(19) United States
(12) Patent Application Publication
(10) Pub. No.: US 2009/0098234 A1
(43) Pub. Date: Apr. 16, 2009

(54) Screw with Carbide Inserts

(75) Inventors: Josef Graetz, Erin (CA); Frank Czerwinski, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/870,790

(22) Filed: Oct. 11, 2007

(51) Int. Cl. B29C 47/38

(52) U.S. Cl. 425/209; 228/177

(57) ABSTRACT

A screw is provided for an injection unit having an inner diameter surface and a raised outer diameter surface on the screw flights. Carbide inserts such as a carbide wire or a plurality of short carbide inserts are mounted to the outer diameter surface to reduce wear on both the screw flights and the inner surface of the extrusion barrel.

### FIELD OF INVENTION

The present invention generally relates to injection units. More specifically, the present invention relates to injection screws used to convey and melt the resin material.

### BACKGROUND OF INVENTION

The injection molding process typically comprises preparing a polymeric (or sometimes metal) material in an injection unit of an injection unit for melting, injecting the now-melted material under pressure into a closed and clamped mold, solidifying the material in its molded shape, opening the mold and ejecting the part before beginning the next cycle. The molding material typically is supplied to the injection unit from a hopper in the form of pellets or powder. The injection unit transforms the solid material into a molten material (sometimes called a “melt”), typically using a feed screw, which is then injected into a hot runner or other molding system under pressure from the feed screw or a plunger unit. A shut off valve assembly is typically provided to stop and start the flow of molten material from the barrel to the molding system.

U.S. Pat. No. 5,135,378 to Catton teaches a twin screw extruder includes screw crests having wear surfaces formed of weld bead, deposited on the edges of the crests and into a groove in the crest to form a plurality of spaced dams or fences across the groove between the edges of the crest, and a molybdenum fitting between the dams. The dams or fences prevent unraveling of the entire molybdenum fitting, in the event of separation between the fitting and the screw.

U.S. Pat. No. 5,935,350 to Raghu, et al teaches an extruder screw having a nickel based hardfacing alloy having the following elemental constituents, by weight: Cr, 16-22%; Mo, 1-7%; Si, 2.5-3.7%; C, 0.8-1.4%; B, 2-3%; Fe, 2-3.9%; Co, 4.3-17%; Ni and incidental impurities, balance. The alloy is in gas-atomized powder form suitable for deposition by plasma transferred arc welding, has a hardness in the range of about 50 Rc to 60 Rc, a coefficient of friction in the range of about 0.12 to 0.13, an ASTM G-65 wear rating in the range of about 20 to 26, and an ASTM G-77 wear rating in the range of about 0.0 to 0.074. A method of enhancing the abrasive wear resistance and metal-to-metal wear resistance of a substrate by welding a Ni based alloy having at least 40% Ni by weight, between 4% and 18% Co by weight, and between 2% and 3% B, onto wear surfaces of the substrate as a coating having a thickness between about 0.025 in. and about 0.5 in. A plastic extruder screw comprising a metallic body having screw flights and a coating on the screw flights, which coating is between about 0.025 in. and 0.5 in. thick, and is a Ni based alloy having between 4% and 18% Co by weight and between 2% and 3% B by weight.

WO patent 03/051609A1 to Kortmann et al. teaches a method for producing a plastification, mixing or conveyor screw with wear-protected screw flights, especially a screw for plastics processing machines, using a strip that contains a wear-protecting material. According to the invention, the strip (1), in the zone in which the screw flights (5) are to be configured, is applied to the surface of the screw base (2) and is then thermally treated so that a wear-protected surface is produced in said zone. The screw flights (5) are then tooled, thereby forming the intervening screw base (4).

### SUMMARY OF INVENTION

According to a first broad aspect of the present invention, there is provided a screw for an injection unit having an inner diameter surface and a raised outer diameter surface, wherein at least one carbide insert is mounted to a portion of the raised outer diameter surface.

According to a second broad aspect of the invention, there is provided method for preparing a screw for an injection unit having an inner diameter surface and a raised outer diameter surface comprising mounting at least one carbide insert to a portion of the raised outer diameter surface.

### DETAILED DESCRIPTION OF DRAWINGS

A better understanding of the non-limiting embodiments of the present invention (including alternatives and/or variations thereof) may be obtained with reference to the detailed description of the non-limiting embodiments of the present invention along with the following drawings, in which

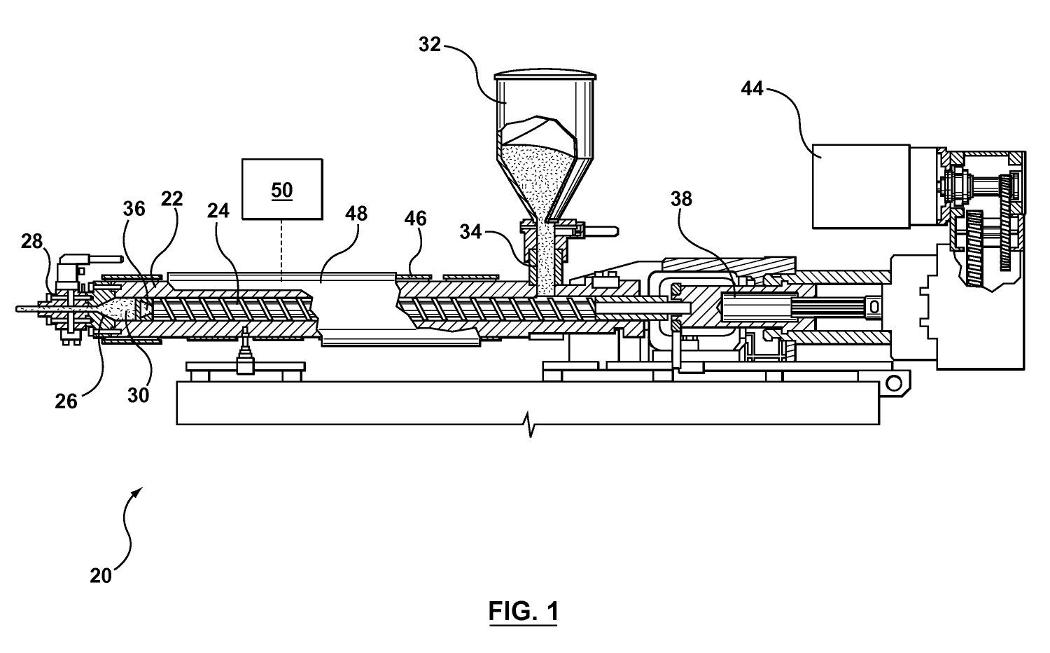

FIG. 1 shows an injection unit having a screw;

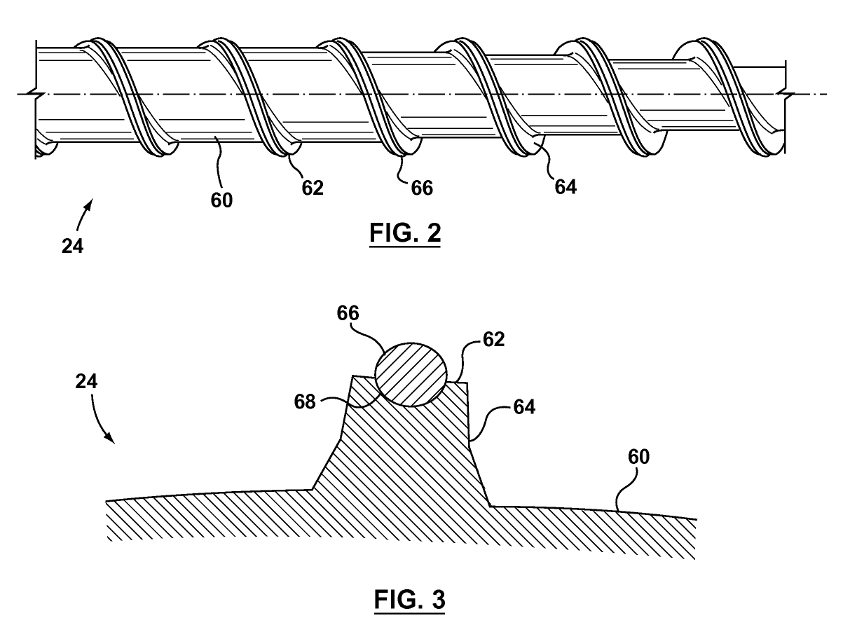

FIG. 2 shows a side profile view of the screw shown in FIG. 1, having a carbide insert in accordance with a first non-limiting embodiment of the invention;

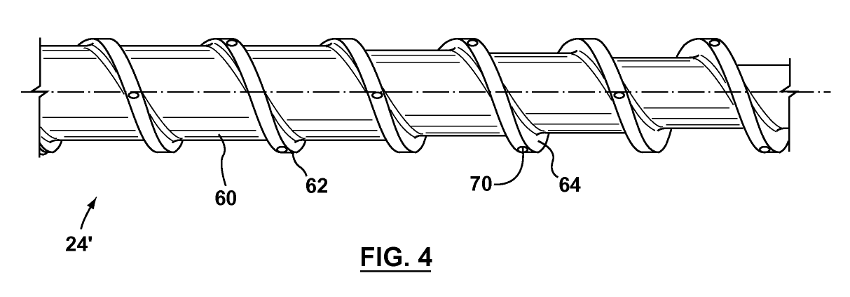

FIG. 3 shows a cross-sectional view of a portion of the screw shown in FIG. 2; and

FIG. 4 shows a side profile of a carbide insert for a screw, in accordance with a second, non-limiting embodiment of the invention.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENTS

Referring now to FIG. 1, an injection unit for a molding system in accordance with a first non-limiting embodiment is shown generally at 20. The injection unit 20 includes an extrusion barrel 22 adapted to receive an injection screw 24. Barrel 22 may include an optional protective liner (not shown). A cylinder head 26 closes off the end of extrusion barrel 22, and mounts a coaxially aligned nozzle 28. A melt channel 30 is defined between them, extending through barrel 22, cylinder head 26 and nozzle 28.

Resin material (typically thermoset or thermoplastic pellets) is fed from a hopper 32, through a feed throat 34 into melt channel 30. The rotational movement of screw 24 plasticizes the material prior to it exiting through nozzle 28. Preferably, screw 24 may include a plurality of specialized zones (not shown). For example, a first zone might be include screw flights adapted for conveying solid material from the hopper 32, a latter zone for shearing and plasticizing the material, and a final zone for mixing the now-molten material prior to exiting through nozzle 28. Screw 24 may also include weirs or channels to separate out unmelted material from the melted material for further processing. Other adaptations will occur to those of skill in the art.

In addition to rotating, screw 24 is preferably operable to reciprocate back and forth to express the melted material out through nozzle 28 and pack the material within a mold (not shown). Preferably, a non-return valve 36 is provided near the tip of screw 24 to prevent the reentry of material during the forward motion of the screw. The rotational movements of screw 24 is provided by a motor 44, which may be an electric motor, a hydraulic motor, or a combination thereof (the embodiment depicted in FIG. 1 shows an electric version of motor 44). The rotational movement of screw 24 helps to melt and mix the molten material. Screw 24 is also translatable within barrel 22 via piston 38, in order to apply injection and hold pressure during the molding process. (The embodiment depicted in FIG. 1 shows a hydraulic version of piston 38).

Heater bands 46 are provided along a portion of the length of barrel 22 (though away from the feed throat 34) to assist in the melting of the material (in addition to the heat generated by the shearing action of screw 24) and then maintain the temperature of the molten material as it approaches the nozzle 28. Preferably, heater bands 46 are covered with an insulating barrel cover 48 to minimize heat loss). Thermocouples 50 are provided along the barrel 22 to provide an indication of the material's temperature.

Referring now to FIGS. 2 and 3, a portion of screw 24 is shown in greater detail. Screw 24 includes an inner diameter portion (I/D) 60, which is substantially defined by the shank of the screw 24, and an outer diameter portion (O/D) 62, which extends further towards the inner surface of barrel 22, and is substantially defined by the conveying screw flights 64. O/D 62 can include other extrusion screw features, such as mixing studs, weirs, etc. (none shown). I/D 60 and O/D 62 can be machined using known screw-manufacturing techniques.

The applicants have observed that at least some portions of screw flights 64 are subject to extensive wear when operated under great heat. Conventional hardfacing of the O/D 62 does not sufficiently prevent deterioration of the screw flights 64 when operating under these high temperature conditions. Furthermore, the inside of barrel 22 is also subject to wear, and must also be periodically replaced (a process significantly more laborious than the replacement of screw 24).

To prevent overheating and improve wear resistance in both barrel 22 and screw 24, the applicant's have mounted a preformed protective carbide insert to a portion of surface of O/D 62. Preferably, the carbide insert is made of tungsten carbide (WC), but alternatively, titanium carbide (WC) or an alloy such as tungsten-carbide-cobalt could also be used. In the presently-illustrated embodiment, the carbide insert is formed as a carbide wire 66 that be applied to some or all of the screw flights 64 in a helical fashion. The screw flights 64 can be flat, or include a groove 68 to help locate the carbide wire 66 on O/D 62. The carbide wire 66 is bonded to the O/D 62.

Referring now to FIG. 4, a second embodiment of the invention is shown generally at 24′. On screw 24′, a plurality of short carbide inserts 70 are bonded to the surface of O/D 62 in a spaced relationship. Preferably, the short carbide inserts 70 are cylindrical, oval or puck-shaped. In the presently-illustrated embodiment, short carbide inserts 70 are evenly spaced along screw flights 64. Alternatively, the short carbide inserts 70 can be located in clusters together, which the clusters spaced evenly along screw flights 64. The screw flights 64 can be flat, or provide a concavity to help locate each of the short carbide inserts 70.

For both embodiments, the carbide inserts are preferably brazed or soldered onto the surface of the O/D 62. Alternatively, the carbide inserts can be mounted via other means such as through the use of mechanical fasteners such as bolts, adhesives or by press-fitting. Preferably, the carbide (in both wire and insert embodiments) has a minimal surface area relate to the screw flight to minimize heat generated by friction between the carbide and the inside surface of the barrel 22.

Non-limiting embodiments of the present invention may provide a screw having improved wear and heat resistance. Non-limiting embodiments of the present invention may also prolong the life of the extrusion barrel.

The description of the non-limiting embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. Therefore, what is to be protected by way of letters patent are limited only by the scope of the following claims.

What is claimed is:

1. A screw for an injection unit having an inner diameter surface and a raised outer diameter surface, wherein at least one carbide insert is mounted to a portion of the raised outer diameter surface.

2. The screw of claim 1, wherein the at least one carbide insert is mounted to the portion of the raised outer diameter surface by brazing.

3. The screw of claim 1, wherein the at least one carbide insert is preformed into its substantially final shape prior to mounting the at least one carbide insert to the raised outer diameter surface.

4. The screw of claim 1, wherein the raised outer diameter surface is formed on a substantially helical screw flight.

5. The screw of claim 4, wherein the at least one carbide insert is a carbide wire mounted around the substantially helical screw flight.

6. The screw of claim 5, wherein a groove is provided in the substantially helical screw flight to help locate the carbide wire.

7. The screw of claim 1 when the at least one carbide insert is a plurality of short carbide inserts mounted in a spaced relationship along a screw flight.

8. The screw of claim 7, wherein the plurality of short carbide inserts is mounted in clusters spaced along the screw flight.

10. The screw of claim 7, where clusters are aligned longitudinally along the length of the screw over every second flight of the screw flight.

11. The screw of claim 1, wherein the at least one carbide insert is made of tungsten-carbide.

12. The screw of claim 1, wherein the at least one carbide insert is made of titanium-carbide.

13. The screw of claim 1, wherein the at least one carbide insert is made of tungsten-carbide-cobalt alloy.

14. A method for preparing a screw for an injection unit having an inner diameter surface and a raised outer diameter surface comprising mounting at least one carbide insert to a portion of the raised outer diameter surface.

15. The method of claim 14, wherein the at least one carbide insert is mounted to the portion of the raised outer diameter surface by brazing.

16. The method of claim 14, wherein the at least one carbide insert is preformed into its substantially final shape prior to mounting the at least one carbide insert to the raised outer diameter surface.

17. The method of claim 14, wherein the raised outer diameter is formed on a substantially helical screw flight.

18. The method of claim 17, wherein the at least one carbide insert is a carbide wire mounted around the substantially helical screw flight.

19. The method of claim 18, wherein a groove is provided in the substantially helical screw flight to help locate the carbide wire.

20. The method of claim 14 when the at least one carbide insert is a plurality of short carbide inserts mounted in a spaced relationship along a screw flight.

21. The method of claim 20, wherein the plurality of short carbide inserts is mounted in clusters spaced along the screw flight.

22. The method of claim 20, where clusters are aligned longitudinally along the length of the screw over every second screw flight.

21. The method of claim 14, wherein the at least one carbide insert is made of tungsten-carbide.

22. The method of claim 14, wherein the at least one carbide insert is made of titanium-carbide.

23. The method of claim 14, wherein the at least one carbide insert is made of tungsten-carbide-cobalt alloy.

24. The screw of claim 1, wherein the at least one carbide insert is mounted to the portion of the raised outer diameter surface by one of soldering, adhesives, mechanical fasteners or press fitting.
